(19) United States
(12) Patent Application Publication
(10) Pub. No.: US 2008/0302204 A1
(43) Pub. Date: Dec. 11, 2008

(54) LOCKING LEVER FOR PIPE CONNECTOR

(76) Inventor: Shen-Chih Lee, Taipei Hsien (TW)

Correspondence Address: PAI PATENT & TRADEMARK LAW FIRM, 1001 FOURTH AVENUE, SUITE 3200, SEATTLE, WA, 98154, US

(21) Appl. No.: 11/758,673

(22) Filed: Jun. 6, 2007

(51) Int. Cl. G05G 1/04

(52) U.S. Cl. 74/519

(57) ABSTRACT

A locking lever having a metal core plate and a plastic cover layer is disclosed. The metal core plate has a plate-like base, an expanded blunt head curving outwardly downwards, and a main through hole and a plurality of small bonding through holes cut through two opposite sides thereof. The plastic cover layer is molded on the core plate, filling up the small bonding through holes, and covers the whole surface area of the core plate to expose the peripheral edge of the expanded blunt head to the outside The plastic cover layer further has a T-shaped cross section at one end, a through hole corresponding to the main through hole of the core plate, a groove at a top side thereof, and a front end and a rear end respectively curved outwardly downwards.

### BACKGROUND OF THE INVENTION

(a) Field of the Invention

The present invention relates to locking levers and more particularly to a durable, inexpensive locking lever for use in a pipe connector.

(b) Description of the Prior Art

Many pipe connectors are known for use to connect pipes. A pipe connector is known comprised of a male connector and a female connector. The female connector has two pairs of lugs symmetrically disposed at two sides to support two locking levers. After insertion of the male connector into the female connector, the locking levers are turned from the unlocking position to the locking position to lock the male connector to the female connector. Under the consideration of strength and durability, locking levers for pipe connectors are commonly made out of copper or other metal material. The material cost for a metal locking lever is high. Further, a metal locking lever tends to rust. When using polypropylene or other plastics to make a locking lever, the locking lever will wear quickly with use.

Therefore, it is desirable to provide a locking lever that eliminates the aforesaid problems.

### SUMMARY OF THE INVENTION

The present invention has been accomplished under the circumstances in view. It is therefore the main object of the present invention to provide a locking lever for pipe connector, which combines a non-metal material with a metal core plate to give a nice outer appearance and save the cost of the material.

### BRIEF DESCRIPTION OF THE DRAWINGS

FIG. 1 is a perspective view of a locking lever for pipe connector in accordance with a first embodiment of the present invention.

FIG. 2 shows a core plate for locking lever according to the first embodiment of the present invention.

FIG. 3 is a schematic drawing showing the cover layer covering the core plate according to the first embodiment of the present invention.

FIG. 4 is a schematic side view of the locking lever according to the first embodiment of the present invention.

FIG. 5 is a sectional view taken along line 5-5 of FIG. 4.

FIG. 6 is a sectional view taken along line 6-6 of FIG. 4.

FIG. 7 shows a core plate for locking lever in accordance with a second embodiment of the present invention.

FIG. 8 shows a core plate for locking lever in accordance with a third embodiment of the present invention.

FIG. 9 is a schematic drawing showing the cover layering the core plate according to the third embodiment of the present invention.

FIG. 10 is an exploded view of a pipe connector, showing an application of the present invention.

FIG. 11 is a sectional side assembly view of the pipe connector shown in FIG. 10.

FIG. 12 is a sectional view taken along line 12-12 of FIG. 11.

### DETAILED DESCRIPTION OF THE PREFERRED EMBODIMENTS

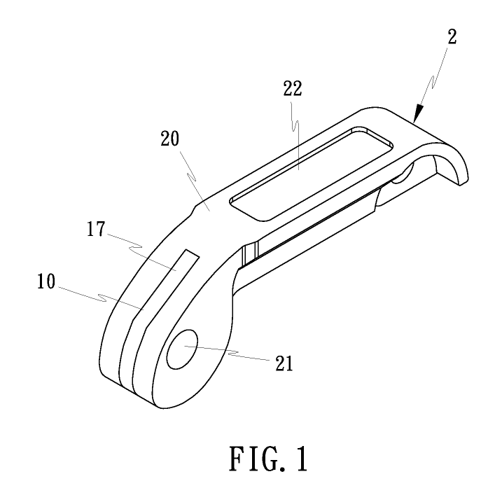

Referring to FIGS. 1˜6, a locking lever 2 for pipe connector in accordance with a first embodiment of the present invention is shown comprised of a core plate 10 and a cover layer 20 (see FIG. 3). The core plate 10 is made out of metal, for example, copper. The core plate 10 has an elongated plate-like base 11, an expanded blunt head 17 extending from one end of the elongated plate-like base 11 and deviated from the longitudinal axis of the elongated plate-like base 11 at a predetermined angle, a main through hole 18 cut through the two opposite sides of the expanded blunt head 17, and a plurality of small bonding through holes 19 cut through the two opposite sides of the expanded blunt head 17 and spaced around the main through hole 18. The cover layer 20 is a plastic member of a certain thickness covering the whole area of the elongated plate-like base 11 and two opposite sidewalls of the expanded blunt head 17, leaving the peripheral edge of the expanded blunt head 17 exposed to the outside. The cover layer 20 has a through hole 21 corresponding to the main through hole 18 of the core plate 10, and a groove 22 at the top side. The front and rear ends of the cover layer 20 are respectively curved outwardly downwards. One end of the cover layer 20 remote from the expanded blunt head 17 of the core plate 10 has a T-shaped cross section with a wide top side and a narrow bottom side (see FIG. 6). The cover layer 20 is directly molded on the core plate 10. During molding of the cover layer 20, the molten plastics filled up the small bonding through holes 19. Therefore, the core plate 10 and the cover layer 20 are integrally bonded together and will not easily separate from each other.

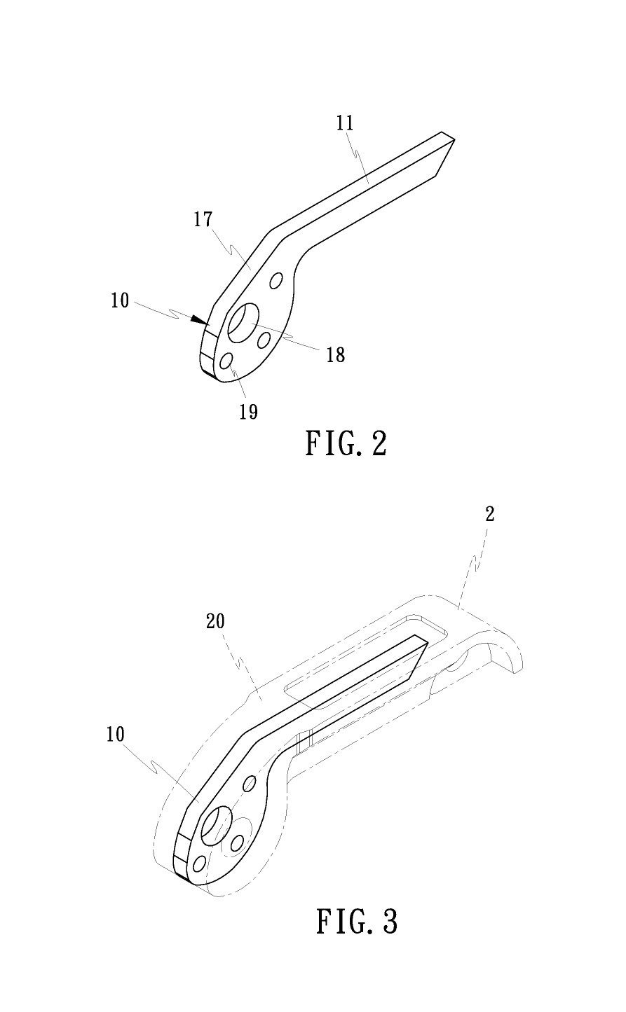

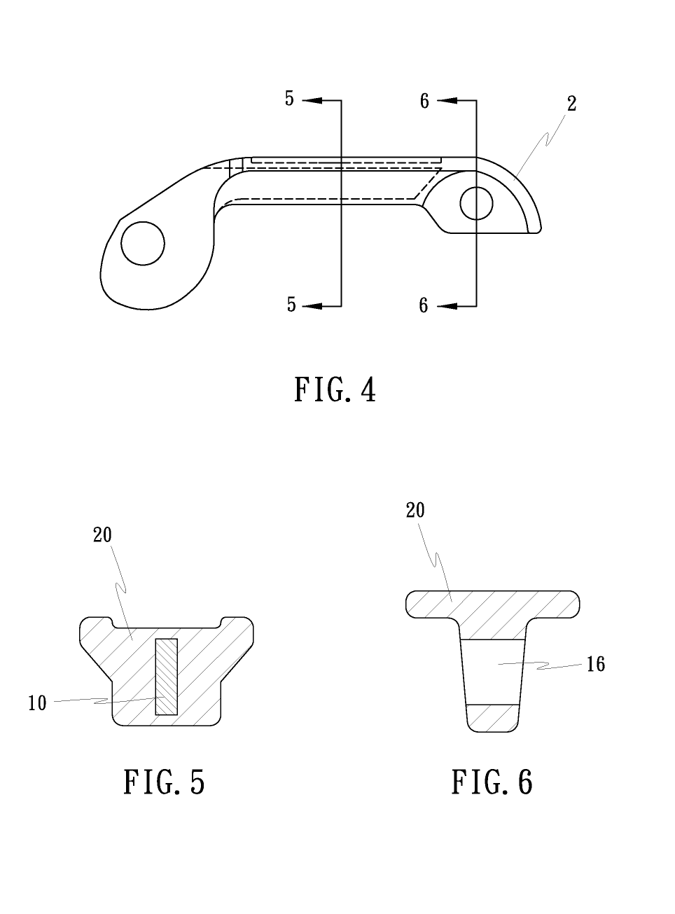

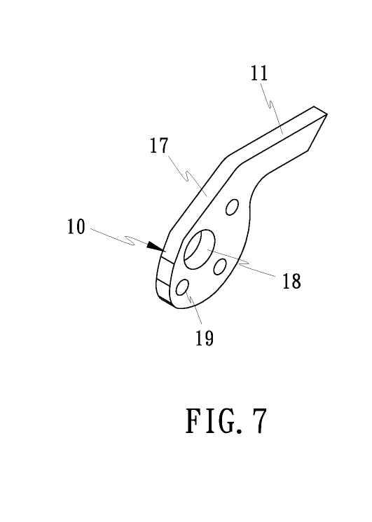

In actual practice, the length of the elongated plate-like base 11 of the core plate 10 is determined according to actual requirements. In the first embodiment of the present invention as shown in FIG. 2, the core plate 10 has a relatively longer elongated plate-like base 11. In the second embodiment of the present invention as shown in FIG. 7, the core plate 10 has a relatively shorter elongated plate-like base 11.

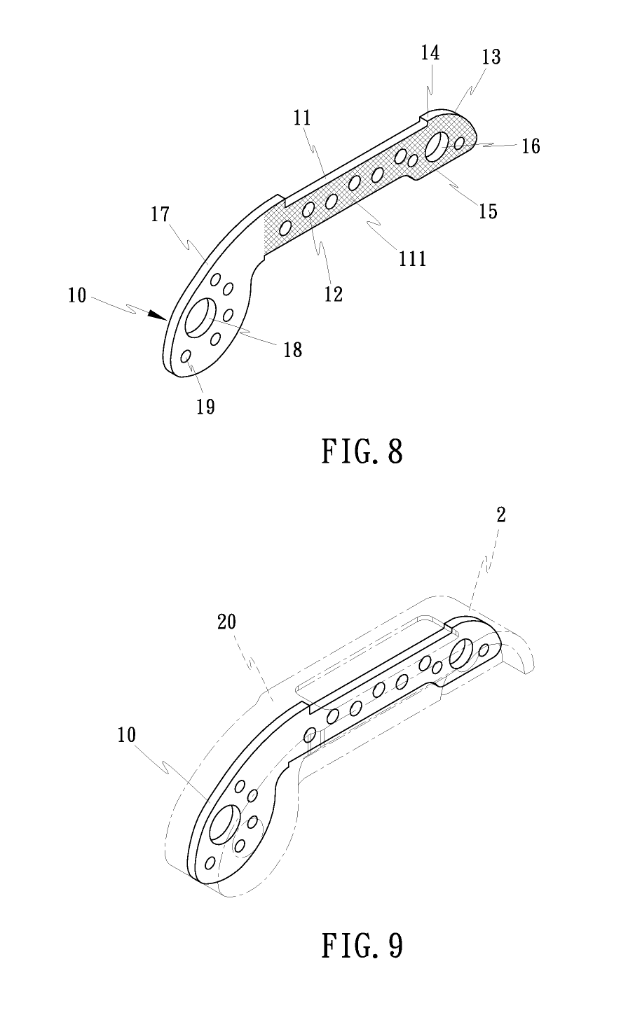

FIGS. 8 and 9 show a third embodiment of the present invention. According to this third embodiment, the core plate 10 has an elongated plate-like base 11, an expanded blunt head 17 extending from one end of the elongated plate-like base 11, and an expanded tip 13 extending from the other end of the elongated plate-like base 11, a main through hole 18 cut through the two opposite sides of the expanded blunt head 17, a plurality of small bonding through holes 19 cut through the two opposite sides of the expanded blunt head 17 and spaced around the main through hole 18, a second main through hole 16 cut through two opposite sides of the expanded tip 13, and supplementary small bonding through holes 12 cut through two opposite sides of the elongated plate-like base 11 and the expanded tip 13. The expanded tip 13 has a top edge 14 and a bottom edge 15. The bottom edge 15 is a flat edge. The top edge 14 curves smoothly downwards toward the bottom edge 15. Further, the small bonding through holes 19 and 12 can be made in circular, oval, or rectangular shape, or any other shape. Further, the elongated plate-like base 11 and the expanded tip 13 have the respective sidewalls embossed with an embossed pattern 111 (see FIG. 8) to enhance the engagement between the cover layer 20 and the core plate 10. According to this embodiment, the expanded tip 13 enhances the structural strength of the locking lever 2.

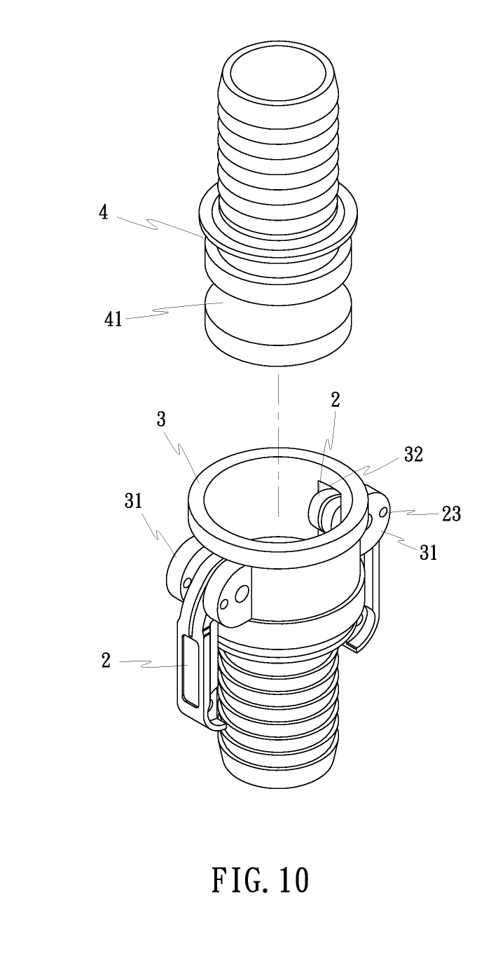

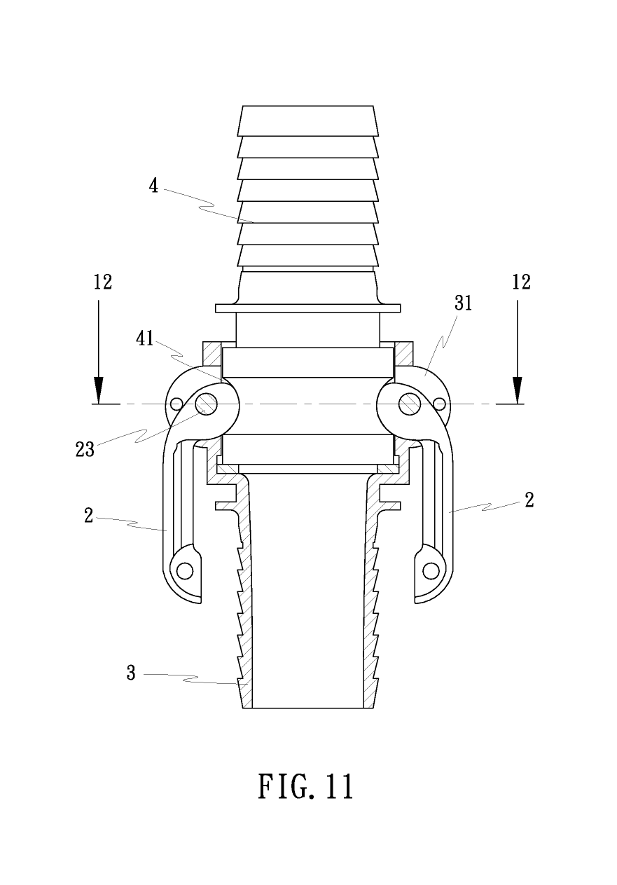

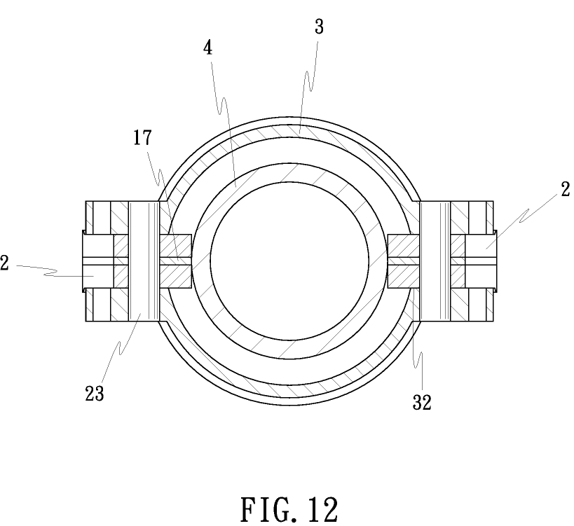

FIGS. 10˜12 show an application example of the present invention in which two locking levers 2 are used in a pipe connector. The pipe connector is comprised of a male connector 4 and a female connector 3. The female connector 3 comprises two through holes 32 aligned at two sides, and two pair of lugs 31 respectively extended from the outside wall at two sides of each of the through holes 32. The two locking levers 2 are respectively pivoted to the two pairs of lugs 31. Two pivot pins 23 are respectively inserted through the through hole 21 of the cover layer 20 and the main through hole 18 of the core plate 10 of each of the two locking levers 2 and then respectively fastened to the two pairs of lugs 31 to pivotally secure the two locking levers 2 to the female connector 3. After insertion of the male connector 4 into the female connector 3, the locking levers 2 are turned to the locking position to force one end (the blunt head) of the cover layer 20 of each locking lever into engagement with the annular locating groove 41 around the periphery of the male connector 4, locking the male connector 4 to the female connector 3. After locking, the top edge of the expanded blunt head 17 of the core plate 10 and the corresponding surrounding area of the cover layer 20 of each of the two locking levers 2 are kept in close contact with the surface of the annular locating groove 41 of the male connector 4 positively against wearing. The design of the present invention reduces the consumption of metal material and the weight of the locking lever 2. The plastic cover layer 20 gives a soft and nice touch, and provides an attractive outer appearance.

In conclusion, the invention provides a locking lever, which utilizes different materials to construct an integrated structure having light and wear resisting characteristics for comfortable and durable use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A locking lever comprising:
a metal core plate, said metal core plate comprising a plate-like base and an expanded blunt head extending from one end of said plate-like base and curving outwardly downwards, said expanded blunt head having a main through hole and a plurality of small bonding through holes cut through two opposite sides thereof; and
a plastic cover layer molded on said core plate, filling up said small bonding through holes and covering the whole surface area of said core plate to expose the peripheral edge of said expanded blunt head to the outside, said plastic cover layer having at one end a T-shaped cross section with a wide top side and a narrow bottom side, a through hole corresponding to the main through hole of said core plate, a groove at a top side thereof, and a front end and a rear end respectively curved outwardly downwards.

2. The locking lever as claimed in claim 1, wherein said plate-like base is a flat plate.

3. The locking lever as claimed in claim 1, wherein said core plate further comprises an expanded tip extending from an opposite end of said plate-like base and embedded in said plastic cover layer and curving outwardly downwards, said expanded tip having a through hole cut through two opposite sides thereof and filled up by said plastic cover layer.

4. The locking lever as claimed in claim 1, wherein said core plate has two embossed opposite sidewalls.

5. The locking lever as claimed in claim 1, wherein said plate-like base has a plurality of bonding through holes filled up by said plastic cover layer.
